(19) United States
(12) Patent Application Publication
(10) Pub. No.: US 2007/0226345 A1
(43) Pub. Date: Sep. 27, 2007

(54) Automated document processing with third party input

(75) Inventor: George William Luckhardt, Los Angeles, CA (US)

Correspondence Address: George W. Luckhardt, PO Box 927951, San Diego, CA, 92192, US

(73) Assignee: IP Filepoint, LLC

(21) Appl. No.: 11/386,421

(22) Filed: Mar. 22, 2006

(51) Int. Cl. G06F 15/16

(52) U.S. Cl. 709/227

(57) ABSTRACT

Automated document processing with third party input is described. A method for document processing includes receiving a first document input from a user at a first terminal, and transmitting the first document input to a second terminal. The method also includes receiving, at the second terminal, a second document input from a reviewer based on the first document input, and transmitting information related to the first document input and the second document input to a third terminal. The first document input may be associated with a patent application. The method may further include prompting the user for the first document input. The second document input may include a certification of the first document input by the reviewer. The method may further include formatting the first and/or second document inputs before the transmission to the third terminal. The second terminal may be located in Hawaii.

### FIELD

The invention relates generally to the field of document processing and, more specifically, to automated document processing.

### BACKGROUND

Official documents, such as tax return forms, may be time consuming to prepare and file with the appropriate agency, e.g. the Internal Revenue Service (IRS). Typically, a paper copy of the form is obtained by the tax filer. The paper form must then be filled out, either by handwriting or typing. Because the paper form must be handwritten or typed, many problems such as illegibility and typographical errors may arise.

Several software applications, such as Turbo Tax®, have been developed to enable the tax filer to fill out the tax forms electronically, e.g. using a personal computer, and file the tax forms electronically, e.g. using an Internet connection. Turbo Tax® prompts the tax filer for answers to various questions and fills out the tax form in response to the answers from the tax filer. Once the tax return is prepared, the tax filer submits the return to the IRS using Turbo Tax® via the Internet connection. However, after submission by the tax filer, the tax form is not reviewed or certified by an agent of Turbo Tax® before the tax form is received by the IRS.

Another type of official document is a patent application. Related to patent application filings, the US Patent and Trademark Office (USPTO) has implemented the Patent Electronic Filing System (EFS) which enables patent application filers to electronically file a US patent application with the USPTO. In usage of EFS, only two parties are involved. The first or sending party is the patent application filer, and the second or receiving party is the USPTO. Thus, all of the EFS required steps for the filing of the patent application must be performed by the sending party, e.g. the patent application filer. Therefore, there is no way for a third party, e.g. a patent attorney, to perform intermediate services, such as certification, in the filing of the patent application on behalf of the first party, e.g. an inventor or invention owner, such as when the client and the patent attorney geographically distant from each other.

For certain patent related filings, such as a Request for Continued Examination (RCE), the filing may be made later if faxed from a later time zone with a Certificate of Facsimile Transmission. However, the unavailability of third party services in execution of the EFS sacrifices utilization of services provided in other geographic areas, e.g. other time zones. Furthermore, the EFS is available only for limited types of patent documents, such as initial patent application filings.

Therefore, there is a need for electronic document processing involving a third party.

### SUMMARY

Accordingly, the present invention is directed to automatic document processing with third party input that overcomes one or more problems due to limitations and disadvantages of the related art.

A method for document processing, according to an embodiment of the present invention, includes receiving a first document input from a user at a first terminal, and transmitting the first document input to a second terminal. The method also includes receiving, at the second terminal, a second document input from a reviewer based on the first document input, and transmitting information related to the first document input and the second document input to a third terminal.

In one aspect of the present invention, the first document input may be associated with a patent application. The method may further include prompting the user for the first document input at the first terminal. The second document input may include a certification of the first document input by the reviewer. The reviewer may be a patent agent or a patent attorney. The method may further include processing and/or formatting the first and/or second document inputs before the transmission to the third terminal.

In another aspect of the present invention, the second terminal is located in Hawaii. The third terminal may be affiliated with the US Patent and Trademark Office (USPTO). In another aspect of the present invention, the second terminal is located in an earlier time zone than the first terminal. The transmitting of the first document input to the second terminal and the transmitting of the information related to the first document input and the second document input to the third terminal may be performed using the Internet, and the first document input and the second document input may be received at the third terminal as a facsimile.

Advantages of the present invention include enabling a third party to provide input, such as review and/or certification, to a document submission. Additionally, if the document is a patent document, and the second terminal is located in Hawaii, the user may benefit from a later effective filing deadline for the patent document by the inclusion of a certificate of facsimile transmission asserting that the patent document was sent via facsimile to the USPTO before midnight, Hawaii Time. Furthermore, a wider range of patent documents may be processed using the present invention than using the EFS. Additionally, because of user prompting and data reformatting, the end user may submit documents through a straightforward question and answer dialog. In addition to patent documents, the present invention may also be utilized to process other types of time-critical, official, legal, medical or other types of documents.

### BRIEF DESCRIPTION OF THE INVENTION

The accompanying drawings, which are included to provide a further understanding of the invention and are incorporated in and constitute a part of this application, illustrate embodiments of the invention and together with the description serve to explain the principles of the invention.

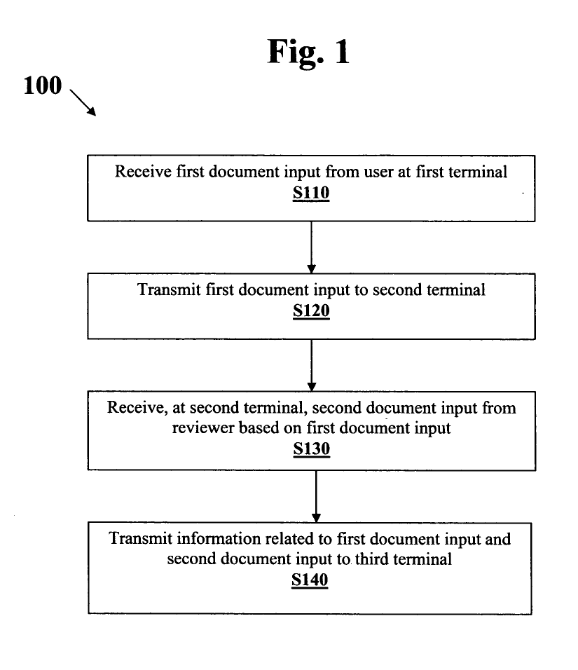

FIG. 1 is a flow diagram illustrating a method for document processing, according to an embodiment of the present invention.

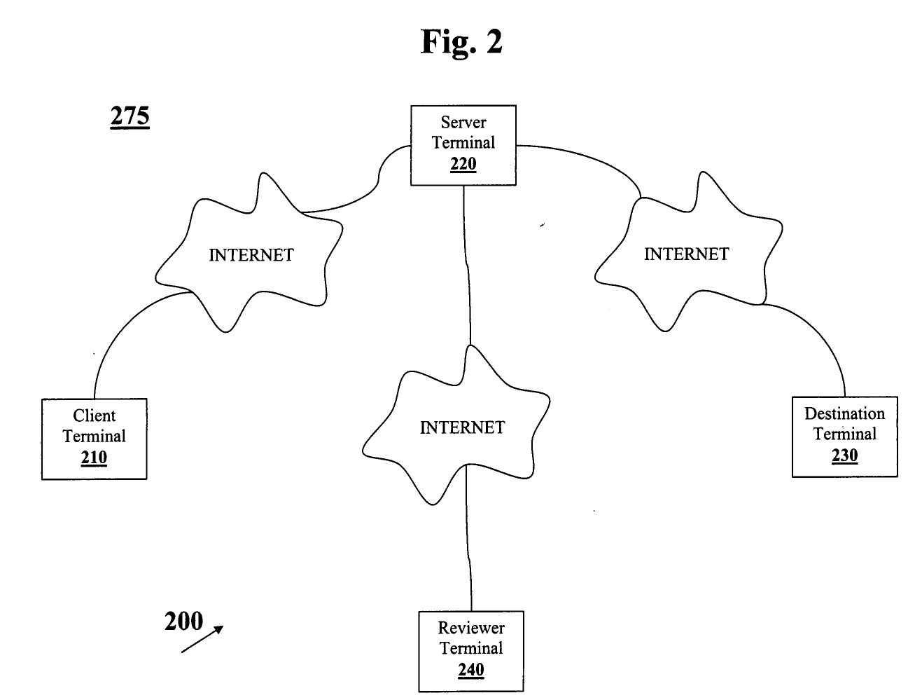

FIG. 2 is a block diagram illustrating an exemplary system for performing the methods of the present invention, operating in an exemplary environment, according to an embodiment of the present invention.

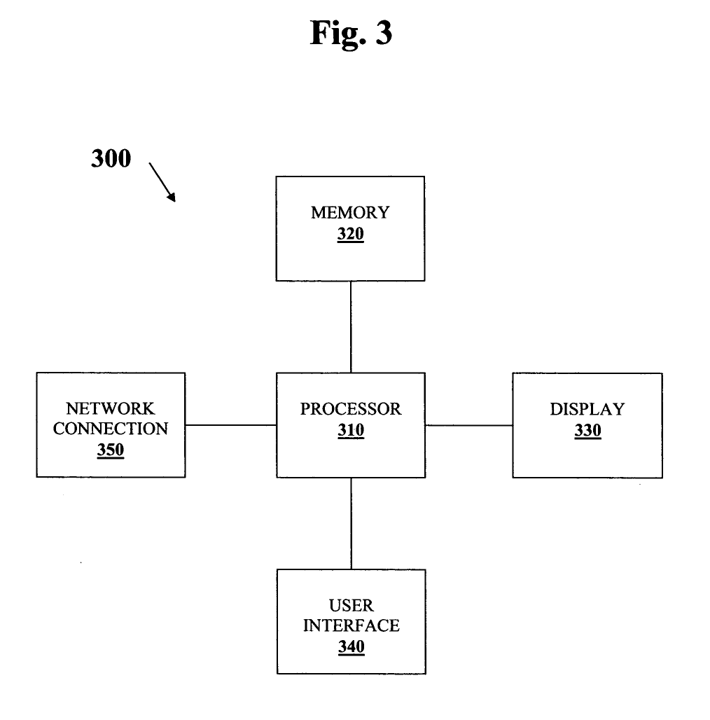

FIG. 3 is a block diagram illustrating an exemplary terminal for use in performing the methods of the present invention, according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Automated document processing with third party input is described. In one embodiment, a corresponding method includes receiving a first document input from a user at a first terminal, and transmitting the first document input to a second terminal. The method also includes receiving, at the second terminal, a second document input from a reviewer based on the first document input, and transmitting information related to the first document input and the second document input to a third terminal. The steps of the method may be embodied in a computer-readable medium, such as software, firmware, or electronic circuitry for example, having stored thereon a program which is executable by a processor. Furthermore, in another embodiment, the method may be implemented using a system that includes a client terminal adapted to receive a first document input from a user, and to transmit the first document input to a server terminal. The system also includes the server terminal communicatively coupled to the client terminal, adapted to receive a second document input from a reviewer based on the first document input, and to transmit information related to the first document input and the second document input to a destination terminal. The methods described herein may refer to methods of doing business, such as a method of filing a patent document with third party input, for example.

FIG. 1 is a flow diagram illustrating a method 100 for document processing, according to an embodiment of the present invention.

Referring to FIG. 1, the method 100 includes receiving a first document input from a user at a first terminal (S110), and transmitting the first document input to a second terminal (S120). The method also includes receiving, at the second terminal, a second document input from a reviewer based on the first document input (S130), and transmitting information related to the first document input and the second document input to a third terminal (S140).

The first document input may be associated with a patent application (e.g., patent document). The method may further include prompting the user for the first document input at the first terminal. That is, the user may be asked to input responses to a question or series of questions, for example. Thus, for example, if the document being processed is a patent document, the user may be asked “What type of document do you wish to file?” and be offered a pull-down menu on the display screen that offers various alternatives such as “Request for Continued Examination” and/or “Information Disclosure Statement”, for example. After selecting a document type, the user may then be asked “What is the patent application serial number?” and/or “What is/are the name(s) of the inventor(s)?” Based upon the user responses to these questions, the first document input is generated for transmission to the second terminal.

The second document input may include a certification of the first document input by the reviewer. In one aspect, the review and/or certification may be performed by a patent agent, an attorney, an accountant, a medical doctor (MD), or other licensed professional. Thus, for example, if the document being processed is a patent document, the certification may include a signature of a patent agent or patent attorney. Alternatively, the review and/or certification may be performed by a reviewer without a special license. The certification may include a certificate of electronic transmission signed by the reviewer. The certificate of electronic transmission may be a certificate of facsimile transmission, for example. The certificate of facsimile transmission may provide certification of the date on which the document was sent, e.g. ‘faxed’, to the United States Patent and Trademark Office (USPTO), for example. As described below, in one aspect of the present invention, the document may be sent via the Internet, yet arrive at its destination terminal as a facsimile (fax). The signature of the reviewer may be input as an electronic signature, for example. That is, the review may not be required to manually write his signature. Instead, the reviewer may input an electronically saved version of his signature, as part of the second document input, for example. In one aspect, the second document input, e.g. electronic signature, may be sent by the reviewer to the second terminal from a fourth terminal.

In one embodiment, different types of patent documents which may be processed include a continued prosecution application (CPA), an amendment, a declaration, a petition, an information disclosure statement (IDS), a terminal disclaimer, a notice of appeal, an appeal brief, a request for continued examination (RCE), an assignment document, an issue fee transmittal, and an authorization to charge a deposit account.

The method may further include processing the first and/or second document inputs before transmission to the third terminal. For example, the first and/or second document inputs may be formatted or reformatted before transmission to the third terminal. Therefore, the method may further include formatting at least one of the first document input and the second document input to generate the information related to the first document input and the second document input before the transmission to the third terminal, for example. Thus, if the document is an IDS, for example, the first document input may be an answer to a question prompted to the user, such as “What US patent would you like to disclose?” The answer provided by the user may be “U.S. Pat. No. 6,103,______”, for example. Before transmission to the third terminal, this and other document inputs are formatted into a standard IDS format, such as a USPTO-approved IDS form. Furthermore, the first document input may be formatted or reformatted before it is displayed at the second terminal to the reviewer. The processing of the first and/or second document inputs before the transmission to the third terminal may also include combining the first and second document inputs. For example, data entered by the user at the first terminal may be combined with a signature from the reviewer at the second terminal. In one aspect, the processing of the first and/or second document inputs before transmission to the third terminal generates the information related to the first and second document inputs.

In another embodiment, the second terminal is located in the state of Hawaii, in the United States of America (Hawaii). Furthermore, the third terminal may be affiliated with the US Patent and Trademark Office (USPTO). For example, the third terminal may be located at a USPTO office location in Virginia. Because the second terminal is located in Hawaii, and the third terminal is affiliated with the USPTO, the user may benefit from a later effective filing deadline for the patent document by the inclusion of a certificate of facsimile transmission asserting that the patent document was sent via facsimile to the USPTO before midnight, Hawaii time.

The transmitting of the first document input to the second terminal may be performed using the Internet. Additionally, the transmitting of the information related to the first document input and the second document input to the third terminal may be performed using the Internet. Furthermore, the transmitting of the first document input to the second terminal and the transmitting of the information related to the first document input and the second document input to the third terminal may be performed using the Internet, and the information related to the first document input and the second document input may be received at the third terminal as a facsimile. A technology similar to EFAX® may be used to send a facsimile document via the Internet, for example. In an alternative embodiment, the information related to the first document input and the second document input may be sent to the third terminal using a facsimile machine, or by mail, for example.

FIG. 2 is a block diagram illustrating an exemplary system 200 for performing the methods of the present invention, operating in an exemplary environment 275, according to an embodiment of the present invention.

Referring to FIG. 2, the system 200 includes a client terminal 210 adapted to receive a first document input from a user, and to transmit the first document input to a server terminal 220. The system 200 also includes the server terminal 220 communicatively coupled to the client terminal 210, adapted to receive a second document input from a reviewer based on the first document input, and to transmit information related to the first document input and the second document input to a destination terminal 230.

The system 200 may further include a reviewer terminal 240 communicatively coupled to the server terminal 220, adapted to receive the first document input from the server terminal 220, to receive the second document input from the reviewer based on the first document input, and to transmit the second document input to the server terminal 220 for subsequent transmission with the first document input to the destination terminal 230.

In one embodiment of the present invention, the server terminal 220 is located in an ‘earlier’ time zone than the client terminal 210. For example, the client terminal 210 may be located in New York where the local time is 11:00 pm, Eastern Standard Time (EST), and the server terminal 220 may be located in California, where the local time is 8:00 pm, Pacific Standard Time (PST), or in Hawaii, where the local time is 6:00 pm, Hawaiian-Aleutian Standard Time (HAST). By such an arrangement, the present invention may benefit from the convergence of virtual space, e.g. digital telecommunications, and physical space, e.g., differences in world time zones. Accordingly, the present invention may provide additional time to the end user (user) for the filing of time-critical documents, for example.

In one aspect, the server terminal 220 is located in Hawaii. The destination terminal may be affiliated with the US Patent and Trademark Office (USPTO). The user may be prompted for the first document input at the client terminal. The transmitting of the first document input to the server terminal and the transmitting of the information related to the first document input and the second document input to the destination terminal may be performed using the Internet, and the information related to the first document input and the second document input may be received at the destination terminal as a facsimile.

Although FIG. 2 shows the terminals, e.g. server/client/review/destination terminals, connected via Internet, as indicated by the ‘Internet clouds’ shown in FIG. 2, the terminals may be connected via any type of wired, wireless, and/or satellite network. That is, the system 200 may be implemented in any type of network environment.

FIG. 3 is a block diagram illustrating an exemplary terminal 300 for use in performing the methods of the present invention, according to an embodiment of the present invention.

With reference to FIG. 3, the exemplary terminal 300, such as the client and/or server terminal (e.g., apparatus) includes a processor 310 adapted to process data, a memory 320 adapted to store data for use by the processor, a display 330 adapted to display information to the user and/or reviewer, a user interface 340, such as a mouse and/or keyboard, adapted to receive user inputs, and a network connection 350, such as an Internet connection, to connect the terminals.

In one embodiment, a server apparatus adapted to process a document includes the processor 310 adapted to receive a first document input from a client terminal, to receive a second document input from a reviewer based on the first document input, and to transmit information related to the first document input and the second document input to a destination terminal. The server apparatus also includes the memory 320 operatively coupled to the processor 310, adapted to store the first and second document inputs for use by the processor 310. The server apparatus also includes the display 330 operatively coupled to the processor 310, adapted to display the first document input to the reviewer. The server apparatus also includes the user interface 340 operatively coupled to the processor 310, adapted to receive the second document input from the reviewer based on the first document input displayed on the display 330, and to transfer the second document input to the processor 310. The user interface 340 may include a graphical user interface (GUI), for example. The reception of the first document input from the client terminal, and the transmission of the information related to the first document input and the second document input to the destination terminal may be made using the network connection 350.

The server apparatus may preferably be located in Hawaii. The destination terminal may be affiliated with the US Patent and Trademark Office (USPTO). The processor may be further adapted to format at least one of the first document input and the second document input to generate the information related to the first document input and the second document input before the transmission to the destination terminal.

In another embodiment, the reviewer terminal 240 may be a mobile handheld computing device, such as a PDA or smartphone, for example. The reviewer may thus review the first document input received from the server terminal 220 via the network connection 350, e.g. a wireless network connection, and transmit the second document input, e.g. an electronic signature, to the server terminal 220 via the network connection 350. Upon receiving the second document input from the reviewer terminal 240, the server terminal 220 then processes the first and/or second document inputs to generate the information related to the first and second document inputs for subsequent transmission to the destination terminal 230. In one aspect, the information related to the first and second document inputs may include a template or form containing data entered based upon the first and second document inputs, for example.

Although the present invention is described with several references to processing patent documents, the present invention may also be implemented for processing any type of document needing third party review and/or certification, such as trademark documents, tax documents, real estate documents, court documents, administrative agency documents, medical documents and/or other types of official documents, for example. Furthermore, the present invention may also be utilized to provide document processing, e.g. document filing services with certification, to legal or other professionals working outside of the United States. For example, a US patent attorney working outside of the United States, such as in Europe or Asia, may need a patent document to be filed with the USPTO from within the United States. The patent attorney may submit the first document input at the first terminal. The second document input may be added at the second terminal and the information related to the first and second document inputs may then be transmitted to the third terminal. Thus, the patent document may be filed with the USPTO from within the United States on behalf of the patent attorney working outside of the United States. Additionally, the present invention may also be configured to operate in any country outside of the United States. For example, the server terminal may be located in London, England, while the client terminal is located in Berlin, Germany.

Advantages of the present invention include enabling a third party to provide input, such as review and/or certification, to a document submission. Additionally, if the document is a patent document, and the second terminal is located in Hawaii, the user may benefit from a later effective filing deadline for the patent document by the inclusion of a certificate of facsimile transmission asserting that the patent document was sent via facsimile to the USPTO before midnight, Hawaii Time. Furthermore, a wider range of patent documents may be processed using the present invention than using the EFS. Additionally, because of user prompting and data reformatting, the end user may submit documents through a straightforward question and answer dialog. In addition to patent documents, the present invention may also be utilized to process other types of time-critical, official, legal, medical or other types of documents.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

1. A method for processing a document, the method comprising:
receiving a first document input from a user at a first terminal;
transmitting the first document input to a second terminal;
receiving, at the second terminal, a second document input from a reviewer based on the first document input; and
transmitting information related to the first document input and the second document input to a third terminal.

2. The method of claim 1, further comprising:
prompting the user for the first document input at the first terminal.

3. The method of claim 1, wherein the first document input is associated with a patent application.

4. The method of claim 1, wherein the second document input comprises a certification of the first document input by the reviewer.

5. The method of claim 4, wherein the certification of the first document input by the reviewer comprises a certificate of electronic transmission.

6. The method of claim 3, wherein the first document input is associated with at least one of a continued prosecution application (CPA), an amendment, a declaration, a petition, an information disclosure statement (IDS), a terminal disclaimer, a notice of appeal, an appeal brief, a request for continued examination (RCE), an assignment document, an issue fee transmittal, and an authorization to charge a deposit account.

7. The method of claim 1, wherein the second terminal is located in Hawaii.

8. The method of claim 1, wherein the reviewer is at least one of a patent agent and a patent attorney.

9. The method of claim 1, wherein the third terminal is affiliated with the US Patent and Trademark Office (USPTO).

10. The method of claim 1, wherein the transmitting of the first document input to the second terminal is performed using the Internet.

11. The method of claim 10, wherein the transmitting of the information related to the first document input and the second document input to the third terminal is performed using the Internet.

12. The method of claim 9, wherein the transmitting of the first document input to the second terminal and the transmitting of the information related to the first document input and the second document input to the third terminal is performed using the Internet, and wherein the information related to first document input and the second document input is received at the third terminal as a facsimile.

13. The method of claim 1, wherein the second document input is sent by the reviewer to the second terminal from a fourth terminal.

14. The method of claim 1, further comprising:
formatting at least one of the first document input and the second document input to generate the information related to the first document input and the second document input before the transmission to the third terminal.

15. A computer-readable medium having stored thereon a program which is executable by a processor, the program comprising instructions for:
receiving a first document input from a user at a first terminal;
transmitting the first document input to a second terminal;
receiving, at the second terminal, a second document input from a reviewer based on the first document input; and
transmitting information related to the first document input and the second document input to a third terminal.

16. The computer-readable medium of claim 15, wherein the program further comprises instructions for:
prompting the user for the first document input at the first terminal.

17. The computer-readable medium of claim 15, wherein the second document input comprises a certification of the first document input by the reviewer.

18. The computer-readable medium of claim 15, wherein the transmitting of the first document input to the second terminal and the transmitting of the information related to the first document input and the second document input to the third terminal is performed using the Internet, and wherein the information related to first document input and the second document input is received at the third terminal as a facsimile.

19. The computer-readable medium of claim 15, wherein the program further comprises instructions for:
formatting at least one of the first document input and the second document input to generate the information related to the first document input and the second document input before the transmission to the third terminal.

20. A system for processing a document, the system comprising:
a client terminal adapted to receive a first document input from a user, and to transmit the first document input to a server terminal;
the server terminal communicatively coupled to the client terminal, adapted to receive a second document input from a reviewer based on the first document input, and to transmit information related to the first document input and the second document input to a destination terminal.

21. The system of claim 20, wherein the user is prompted for the first document input at the client terminal.

22. The system of claim 20, wherein the server terminal is located in Hawaii.

23. The system of claim 20, wherein the destination terminal is affiliated with the US Patent and Trademark Office (USPTO).

24. The system of claim 20, wherein the transmitting of the first document input to the server terminal and the transmitting of the first document input and the second document input to the destination terminal is performed using the Internet, and wherein the information related to the first document input and the second document input is received at the destination terminal as a facsimile.

25. The system of claim 20, further comprising:
a reviewer terminal communicatively coupled to the server terminal, adapted to receive the first document input from the server terminal, to receive the second document input from the reviewer based on the first document input, and to transmit the second document input to the server terminal for subsequent transmission with the first document input to the destination terminal.

26. The system of claim 20, wherein the server terminal is located in an earlier time zone than the client terminal.

27. A server apparatus adapted to process a document, the server apparatus comprising:
a processor adapted to receive a first document input from a client terminal, to receive a second document input from a reviewer based on the first document input, and to transmit information related to the first document input and the second document input to a destination terminal;
a memory operatively coupled to the processor, adapted to store the first and second document inputs for use by the processor;
a display operatively coupled to the processor, adapted to display the first document input to the reviewer; and
a user interface operatively coupled to the processor, adapted to receive the second document input from the reviewer based on the first document input displayed on the display, and to transfer the second document input to the processor.

28. The server apparatus of claim 27, wherein the server apparatus is located in Hawaii.

29. The server apparatus of claim 27, wherein the destination terminal is affiliated with the US Patent and Trademark Office (USPTO).

30. The server apparatus of claim 27, wherein the processor is further adapted to format at least one of the first document input and the second document input to generate the information related to the first document input and the second document input before the transmission to the destination terminal.
